(19) United States
(12) Patent Application Publication
(10) Pub. No.: US 2022/0289990 A1
(43) Pub. Date: Sep. 15, 2022

(54) LIGHT DIFFUSING INK FOR PRINTING ON TRANSPARENT SUBSTRATES

(71) Applicant: EPTAINKS S.P.A., Milano (IT)

(72) Inventors: Annalisa COLOMBO, Milano (IT); Matteo GALLIGANI, Milano (IT)

(73) Assignee: EPTAINKS S.P.A., Milano (IT)

(21) Appl. No.: 17/632,295

(22) PCT Filed: Jul. 30, 2020
(86) PCT No.: PCT/IB2020/057216

§ 371 Date: Feb. 2, 2022

(30) Foreign Application Priority Data
Aug. 2, 2019 (IT) 102019000013911

(51) Int. Cl. C09D 11/037; C09D 11/033; C09D 11/107

(52) U.S. Cl. CPC C09D 11/037; C09D 11/033; C09D 11/107

(57) ABSTRACT

A light diffusing ink for printing on transparent substrates suitable for being integrated with devices for lighting said substrate from the edge, in order to print drawings, graphics, letters on said substrate and also to realize a full-field background whose thickness varies as a function of users' requirements on the surface of said substrate. The coating printed on said substrate is consequently only visible whenever said substrate is lit laterally, whereas it is not visible in the absence of a lateral light.

### OBJECT OF THE INVENTION

The present invention relates to a light diffusing ink for printing on a transparent substrate suitable for being integrated with devices for lighting said substrate from the edge, in order to print drawings, graphics, letters on said substrate and also to realize a full-field background (collectively shortly referred to as coating) having a thickness varies as a function of users' requirements on the surface of said substrate. The coating printed on said substrate is consequently only visible whenever said substrate is lit laterally, whereas it is not visible in the absence of a lateral light.

### PRESENT STATUS OF THE ART

Hybrid nanocomposites, namely organic matrices in which inorganic nanoparticles are dispersed, are extensively studied since allow to improve chemical, physical or mechanical properties compared to the pure matrix, according to the chosen inorganic phase.

Among those improvements, we learned from the document WO2018085376 that it is possible to realize repelling coating by using hydrophobic nanoparticles.

In particular, said document discloses a nanocomposite ink comprising hydrophobic SiO₂ or ZnO nanoparticles having a hydrodinamic diameter of about 10 nm, an organic solvent, and a methylphenyl silicone resin, which is printed—inter alfa—on a glass surface with a thickness, which is less than 20 micrometers.

Among the physical properties, research and technological activities focused on the optical ones, such as the change (increase) of the refractive index, anti-glare, luminescence and light scattering. In relation to the development of anti-glare coatings for light irradiated surfaces, the document US20160145441 teaches a nanocomposite ink composition comprising inorganic non-oxide particles, such as ZnS, having an average hydrodinamic particles size of 50-2000 nm, organic solvent and curable compounds. The ink is applied to transparent substrates with a maximum thickness of 10 micrometers.

Another application is shown in the document WO2017065641 regarding a sol-gel ink based on crystalline TiO₂ nanoparticles with a hydrodinamic diameter ofless than 200 nm, with a percentage of TiO₂ amorphous phase less than 5% in weight. It allows to obtain high refractive index coatings.

The documents above mentioned take advantage of using nanoparticles in order to prepare inks able to provide super-hydrophobic, anti-glare and high refractive index coatings, respectively. Those documents do not teach or suggest how to diffuse the light coming from the edge of transparent substrates, such as a window.

It Is known tliat the diffused light, like that coining from a window that is not directly exposed, is the most comfortable one.

An outstanding feature of the most popular artificial light sources is in that they are concentrated in the form of point or linear sources. A drawback of such feature is in that it disturbs or dazzles users if looked at directly, and another drawback is in that the lighting of solid objects is worse than that obtained by a diffused light, in particular when the shadows produced by concentrated sources are sharp and irritating.

The prior art solution adopted for reducing dazzling consists of applying planar diffusers in front of sources. Such solution is insufficient in that the lighting improvement achieved is minimum in dark shadows, being the dimensions of diffusers rather limited.

In order to overcome this problem, the dimensions of the light source should be increased substantially, which can be obtained by increasing the distance of the diffuser from the source, which would result in a lighting system that is bulky and excessively deep.

In order to get less bulky solutions, liquid crystal display (LCD) backlit panels have been developed, wherein linear light sources arc placed at the edge of a transparent panel which operates as an optical guide all along its length. However, a drawback of such panels, which are used for example as placards, is in that their light distribution is not uniform on their surfaces. Such drawback is even more apparent in the case of big-size panels.

The status of the art presents various solutions for taking light out of a panel uniformly. The solution disclosed in document WO 2012/041480 is disclosed for the purposes of the present description. This document discloses a lighting solid device formed of a panel made from a transparent, polymeric material containing phosphor and diffuser particles internally thereto, equipped with one or more blue LEDs at the edge. Said blue LEDs are arranged along the perimeter of the panel and the phosphor and diffuser particles feature a concentration that grows as a function of the distance from the LEDs, according to a physical pattern which is well defined for each of the two particle types.

A drawback of the just described lighting device is in that it is unable to realize any drawings or letters through a controlled distribution of phosphors and diffusers.

If one wishes to adopt such lighting device as a support for making letters and/or drawings appear upon switching on light sources, preferably LEDs, it would be necessary for him/her to apply adhesives with the desired drawings or letters on the outer surfaces of the diffuser panel. Said adhesives are also partially visible while the device is switched off and unfortunately such feature obviously constitutes a disadvantage.

A similar adhesive-based solution is also adopted for backlit panels and for these solutions too the adhesive support being partially visible along with the desired drawings and/or letters constitutes a disadvantage thereof.

The main disadvantage of the above mentioned prior art supports is in that there are no printing inks that are invisible to human eyes in the absence of light, i.e. while the panel is switched off.

It should be possible to provide an ink having such characteristics, it would be possible to print not only the desired drawings and letters, but also full-field or variable concentrations backgrounds, not visible to human eyes. In order to achieve these results, the ink to be realized should be applied on organic polymer-based, e.g. cast PMMA-based, optically transparent panels. The functionality of such ink might also be extended by applying it onto glass panels.

### DESCRIPTION OF THE INVENTION

Definitions

The definitions of the technical and scientific terms used in this document encompass definitions as they are intended in the moment when this patent application is filed. These definitions shall not be construed restrictively, in that there might be other aspects of the definitions that are not mentioned here, for example those commonly understood by a person skilled in the art that the invention(s) belong(s) to. All patents, patent applications, public patent applications, and publications, web sites, and other published materials which reference is made to in the different paragraphs of this entire document are incorporated in their entirety for reference, unless otherwise specified. If a plurality of definitions exist for the terms here used, those mentioned in this section prevail.

It is understood that the above general description and the detailed description that follows are made for exemplary and illustrative purposes only, and they do not limit the scope of the argument here claimed. In this patent application, the use of singulars includes plurals, unless otherwise specified. In this patent applications, the use of the term “comprising” and other forms, for instance “it comprises” and “comprised”, is not limitative, unless otherwise specified.

In this context, the ranges of values and the quantities are possibly expressed in terms of “approximately” a particular value or range of values. “Approximately” also comprises the exact quantity. Therefore, “approximately 10%” means “approximately 10%” as well as “exactly 10%”.

In this context, the singular form “a” and “the” also comprise the plural references, unless the context does not clearly indicate the contrary.

In this context, “matrix” and “organic matrix” are used as synonymous.

### DESCRIPTION

The known transparent solvent-based or water-based inks are generally made with at least an organic resin, some additives and at least a solvent or water.

The known transparent UV-based inks are generally made with monomers, oligomers, in some cases organic resins and some additives including photoinitiators.

The additives shall be chosen according to the nature of the ink. In particular, they shall be mainly surface tension modifiers and adhesion promoters for water-based and solvent-based inks, while higher amount of additives for UV inks shall be constituted of photoinitiators, in addition to surface modifiers and adhesion promoters.

For the present document we named “matrix” (M) the compositions above listed.

The coatings obtained by said inks are transparent but do not allow to diffuse the light coming from the edge of a transparent substrate on which they are printed.

The scope of present invention is a light diffusing ink suitable for being applied onto a transparent substrate, such as a panel to be lighted laterally, in particular a panel suitable for being integrated with devices used to light from the edge of said substrate. In order to reach the scope of the invention the substrate is characterized by edges of at least 3 mm of thickness to favor the entrance of the light laterally.

Once the ink is printed on said substrate, this ink is such as to diffuse light when said substrate is lighted laterally, whereas it is not visible in the absence of lateral light. Said ink can be used, for example, if one wishes to use said support to make letters and/or drawings appear when the support is switched on only, as with placards, shop windows, windows, car glasses, etc. The subject ink can be printed on the whole surface of the substrate, even at variable concentrations, so as to coat said substrate. In this way, let's think for example to a transparent wall of an office implemented by a glass substrate and print-coated by an ink according to the present invention; a transparent wall is obtained when the light from the edge of the substrate is off, thus making the inside of that office visible from the outside; conversely, when the light coming from the edge of the substrate is on, the mentioned ink coating may become visible, thus decorating the wall of the office and making it less visible from the outside.

In order to exhaustively illustrate the present invention, the terms “print”, “printed”, etc. are used to identify the application of an ink according to die present invention on the above-mentioned substrate in any ways. Such application might take place not only by way of printing techniques, but also by using other techniques such as, for exemplary non-exhaustive purposes, paint gun, spray painting, and electrostatic painting.

The ink according to the present invention comprises a matrix (M) wherein an inorganic light diffusing inorganic oxide agent (I) is dispersed, in order to diffuse the light, surprisingly.

In order to obtain a transparent coating with good diffusion properties, the diffuser shall not optically absorb in the visible range, they shall have high refractive index and they shall be well dispersed in the matrix. All these requirements have been obtained by using inorganic oxide agents, surprisingly.

In order to achieve the requested performances, the inorganic agent (I) shall have a index of refraction higher than 1.8 measured at 589 mm, as established by the scientific literature.

After a sequence of experimental verifications, the inorganic oxide agent (I) of the ink according to the present invention has to be selected from zinc oxide (ZnO), zirconium oxide (ZrO₂), titanium dioxide (TiO₂), preferably anatasc Moreover, the average hydrodynamic diameter, measured by Dynamic Light Scattering (DLS), of the inorganic oxide agent (I) dispersed in the matrix has to be comprised between 100 nm and 500 nm, preferably between 150 nm and 250 nm. For this reason, the ink containing one of said inorganic oxide agents (I) makes the drawings or letters printed for the full field background, i.e. the coating, visible on said panel only if it is lit laterally, as better illustrated below.

In the ink compositions according to the present invention, the total amount of the inorganic oxide agent (I) is less than 5.0%, expressed as a percentage (%) by weight of the ink composition.

In the ink compositions here considered, the total amount of the organic matrix (M) is at least 95% by weight of the ink, expressed as a percentage (%) by weight of the ink composition. The remaining part is the inorganic oxide agent (I). In water-based or solvent-based inks, the organic matrix (M) comprises at least a resin (R) in an amount ranging from 20% to 50% by weight of the ink, either dispersed or dissolved in the volatile component, water or solvent respectively, live remaining part of matrix is constituted by additives and the volatile phase (solvents or water) in the quantity known by the expert of the field.

In UV-based inks, the organic matrix (M) has the bases of alternatively monomer (MO), oligomer (O), monomer (MO) and oligomer (O) at least one resin (R) dissolved in monomers (MO), at least one resin (R) dissolved in oligomers (O), at least one resin (R) dissolved in monomers (MO) and oligomers (O). Said matrix (M) is at least 95% by weight of the ink. The amount of the additives within the matrix is known by the expert of the field.

The monomers (MO) forming the organic matrix (M) of the ink are acrylates or methacrylates, both monofunctional or bifunctional or trifimctional or polyfunctional; the oligomers (O) belong to at least one of the chemical families including urethane acrylate, urethane methacrylate, epoxy acrylate, epoxy methacrylate, polyester acrylate, polyester methacrylate, polyester acrylate, polyester methacrylate, amino acrylate, amino methacrylate, oligoamino acrylate, and oligoamino methacrylate oligomers.

The resin (R) belongs to at least one of the chemical families including: polyacrylic, functionalized polyacrylic, polymethacrylic, functionalized polymethaerylic, polyvinylic, functionalized polyvinylic, polyester, hydrocarbonic, ketonic, aldehydic, maleic, polyphenolic, polyethylenic, alkydic, ureic, melaminic, polyamidic, polyamina, epoxy, epoxy-ester, epoxy-urethane, silicone, fluorinate, and cellulose derivative families. The list of the chemical families mentioned above with reference to the resin (R) is common to water-based inks, solvent-based inks, and UV-based inks. The organic matrix (M) might also comprise at least one fluorescent material (F) in a percentage lower than 5.0% by weight of the ink. In order to impart a fluorescent effect to the applied ink, said fluorescent material (F) shall be suitable for at least partially absorbing the electromagnetic spectrum that characterizes the light coming from the lighting device.

Said fluorescent material (F) is alternatively an organic material, preferably selected from phthalocyanines, pyridines, azo pigments, or an inorganic material, preferably selected from ZnS-, ZnSe-, InP-based fluorescent nanoparticles.

In order to obtain the visibility characteristics in the presence of light coming from the edge and optical transparence in the absence of a lateral light, the printing thickness of the ink according to the present invention aiming at realizing drawings, graphics, letters, or full-field. backgrounds (shortly collectively referred to as coating) shall be comprises between 2 μm and 20 μm.

Said coating is obtained upon termination of evaporation of the volatile component in the case of water-based and solvent-based inks, whereas film formation takes place via polymerization with an appropriate source in the case of UV-based inks.

Such coating realizes the optical and mechanical characteristics of the ink according to the present invention by way of a cast-PMMA-based or extra-clear glass optically transparent substrate.

### EXAMPLES

A light diffusing ink for printing on a substrate, such as a transparent panel, in particular one suitable for integrating with devices aiming at lighting said panel from the edge, can feature various compositions.

A number of compositions are indicated below for exemplary purposes only, but they shall not be construed in a limitative sense.

Example 1 deals with the composition of a solvent-based ink for silk-screen printing on cast PMMA.

Example 2 deals with the composition of a solvent-based ink for silk-screen printing on extra-clear glass.

The viscosities of the inks used in examples 1 and 2 have been optimized for printing by using a solvent.

Example 3 deals, for exemplary purposes only, with the composition of an UV-based ink for digital printing on an optically transparent substrate properly pre-treated for receiving the ink.

The viscosity and the surface tension of the ink used in example 3 have been optimized for Inkjet printing by means of a head EPSON DX4.

All of the above-mentioned inks can be made fluorescent as in the formulation indicated in example 4 for extra-clear glass.

Example 1: A solvent-based ink formulated with a nanostructured TiO₂-based inorganic oxide material (I), mostly anatase, in an amount of 0.5% by weight of the ink and 1.5% by dry weight of the ink, The average hydrodynamic diameter of the inorganic oxide material (I) is 300 nm as measured according to a Dynamic Light Scattering (DLS) analysis, The organic matrix (M) of the ink used comprises a resin (R) amounting to 27.5% by weight of the ink and a solvent amounting to 71.0% by weight of the ink. The dry content of the ink, given by inorganic material (I) plus resin (R) and any additives used to foster ink printability, equals 29.0% by weight of the ink, Specifically, the ink according to the present example is formulated as follows:

| | | |
|---|---|---|
| Inorganic material (I): | nanostructured TiO₂ | 0.5% |
| Resin (R): | Acryl-based resin | 16.5% |
| | Vinyl-based resin | 11.0% |
| Solvent: | Butylglycol acetate | 23.0% |
| | Dimethylsuccinate | 20.0% |
| | Propylglycol diacetate | 18.0% |
| | Cyclohexanone | 10.0% |
| Additives: | Surface tension modifiers | 1.0% |

Example 2: A solvent-based ink for glass formulated with a nanostructured TiO₂-based inorganic material (I), mostly anatase. amounting to 0.4% by weight of the ink and approximately 0.7% by dry weight of the ink. The average hydrodynamic diameter of the inorganic material (I) is 150nm as measured according to a DLS analysis. The organic matrix (M) of the ink used comprises a resin (R) amounting to 50.0% by weight of the ink and a solvent amounting to 44.0% by weight of the ink. The dry content of the ink, given by the inorganic material (I) plus the resin (R) and any additives used to foster ink printabilily, equals 57.0% by weight of the ink.
Specifically, the ink according to the present example has been formulated as follows:

| | | |
|---|---|---|
| Inorganic material (I): | Nanostructured TiO2 | 0.4% |
| Resin (R): | Functionalized acrylic resin | 50.0% |
| Solvent: | Butylglycol acetate | 16.0% |
| | Butyldiglycol | 14.0& |
| | Mixture of dibasic esters | 14.0% |
| Additives: | Surface tension modifiers | 2.0% |
| | Glass adhesion promoter | 3.6% |

The ink has been admixed with 16 parts of cycloaliphatic isocyanate per 100 parts of ink before proceeding with printing. The printed glass has subsequently been submitted to a thermal treatment at 150° C. for 30 minutes, in order to foster catalysis.
Example 3: An UV-based ink formulated with a TiO₂-based inorganic material (I), mostly rutile, amounting to 1.0% by weight of the ink and its dry weight, with an average hydrodynamic diameter of 300 nm as measured according to a DLS analysis. The organic matrix (M) of the ink used comprises 88.0% of monomers (MO) and 4.5% of oligomers (O) by weight of the ink, as well as additional additives for printing, known to those skilled in the art, amounting to 6.5% by weight of the ink, so that the UV-based organic matrix (M) equals the remaining 99.0% by weight of the ink.

Specifically, the ink according to the present example has been formulated as follows:

| | | |
|---|---|---|
| Inorganic material (A): | TiO2 | 1.0% |
| Monomers (M): | Benzylacrylate | 40.0% |
| | VEEA | 30.0% |
| | 1.6 Hexandioldiacrylate | 11.0% |
| | DPGDA | 7.0% |
| Oligomer (O): | Trifunctional acrylate oligomer | 4.5% |
| Additives (A): | UV photoinitiators | 6.0% |
| | Surface tension modifiers | 0.5% |

The thus prepared ink features a viscosity of approximately 7 cP and a static surface tension of 25 mN/m, which parameters are suitable for a printing made by way of piezo heads, such as EPSON DX4.
Example 4: A solvent-based ink formUlated as with example 2, modified through the addition of a fluorescent doping agent (F), capable of converting the color of a given light source (in this case, a blue light at 450 nm coming from a blue LED strip) into another color (in this case, a green light).
Specifically, the ink according to the present example, has been formulated as follows:

| | | |
|---|---|---|
| Inorganic material (A): | Nanostructured TiO₂ | 0.4% |
| Resin (R): | Functionalized acrylic resin | 49.95% |
| Solvent (S): | Butylglycol acetate | 16.0% |
| | Butylglycol | 14.0% |
| | Mixture of dibasic esters | 14.0% |
| Additives (A): | Surface tension modifiers | 2.0% |
| | Glass adhesion promoter | 3.6% |
| Fluorescent (F) | Lumogen ® F Yellow 083 (BASF) | 0.05% |

The ink has been admixed with 16 parts of cycloaliphatic isocyanate per 100 parts of ink before proceeding with printing. The printed glass has subsequently been submitted to a thermal treatment at 150° C. for 30 minutes, in order to foster catalysis.

### DESCRIPTION OF THE DRAWINGS

FIG. 1 shows a print of the ink according to example 1, paired with a traditional blue color ink, deposited on a transparent cast PMMA plate via a silk-screen printing process using a 120 threads/cm frame.

The drawing printed on the plate is a full-field rectangle, apart from a writing “EPTAINKS” in the middle, The left-hand half of the rectangle is obtained by printing a traditional blue ink, whereas the right-band half of the rectangle is obtained by printing the ink according to example 1.

The light source of the optical device is a white LED strip, used to light the transparent substrate from the lower edge.

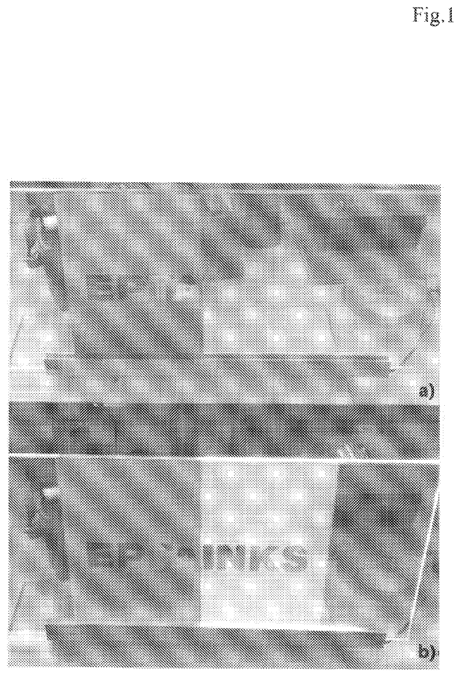

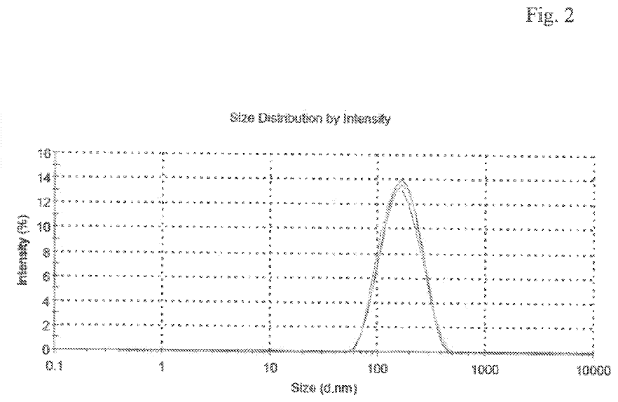

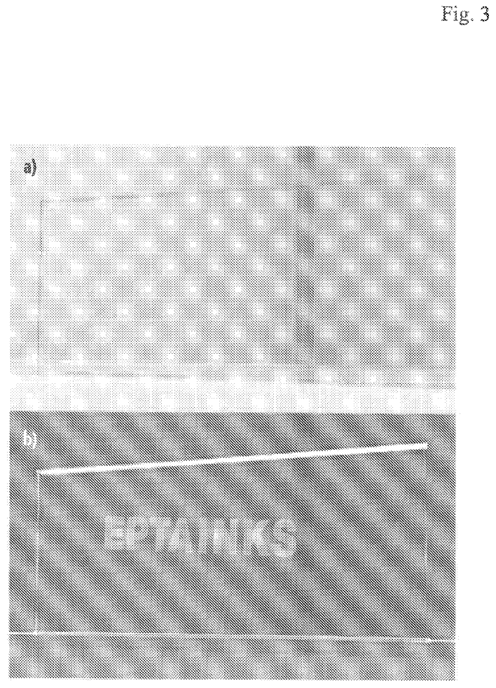

As shown in FIG. 1, the ink according to example 1 is not visible in the absence of light, and also no drawings or letters are visible. On the contrary, note that the part treated with a traditional ink is visible and half-reveals a part of a blue colored rectangle internally to which a writing “EPTA” is apparent-in negative-(see the photograph identified by the letter “a”).

Once the source is on (see the photograph identified by the letter “b”), the ink according to example 1 diffuses a light of the same “color” as that coming from the source, in this case white light, and shows the second half of the rectangle in a white color and the writing “INKS” in negative.

FIG. 2 shows the average hydrodynamic diameter of the inorganic material (I) dispersed within the ink described in example 2, as measured according to the Dynamic Light Scattering (DLS) analysis. The ink has been diluted 1:50 with one of the solvents present in the formula, so as to get a low-viscosity optically diluted solution. In the prepared solutions, viscosity has been measured by using a viscometer Brookfield LV and has been used as a parameter in performing the analysis.

FIG. 3 shows a print of the ink according to example 4, deposited on an extra-clear glass plate by ray of a silk-screen printing process using a 120 threads/cm frame.

The light source of the optical device is a blue LED strip, used to light the transparent substrate from the lower edge.

As shown in the image, no ink is visible in the absence of light (see the photograph identified by the letter “a”). Once the blue source is switched on (see the photograph identified by the letter)“b”), the plate guides the blue light all throughout the surface. When light finds the writing “EPTAINKS” printed with the ink according to example 4, it emits a light spectrum different from that coming from the source, owing to the diffusion and fluorescence optical phenomena; in this case, the writing “EPTAINKS” diffuses green light instead of blue light.

1.-8. (canceled)

9. A screen printing light diffusing ink for printing on an optically transparent substrate, such as a panel preferably made with glass, polymethylethacrylate, polycarbonate and being integrable with devices used to light said substrate from an edge with a light incident angle less than 42° and being said ink visible in the presence of light coming from the edge of said panel and optically transparent in the absence of light coming from the edge of said panel once printed, comprising an organic matrix and having a light diffusion inorganic oxide agent dispersed in the matrix, wherein the light diffusing inorganic oxide agent has a refractive index minimum of 1.8 measured at 589 nm and an average hydrodynamic diameter, measured by Dynamic Light Scattering (DLS), comprises between 100 nm and 500 nm, preferably between 150 nm and 250 nm.

10. The screen printing light diffusing ink according to claim 9, wherein the inorganic oxide agent is present in an amount less than 5.0% by weight of said light diffusing ink.

11. The screen printing light diffusing ink according to claim 9, wherein the inorganic oxide agent is preferably selected from zinc oxide, zirconium oxide, titanium dioxide.

12. The screen printing light diffusion ink according to claim 9, wherein the organic matrix is a solvent-based matrix comprising at least one resin dissolved in solvents in an amount from 20% to 50% by weight of the screen printing light diffusing ink and said matrix being at least 95% by weight of the screen printing light diffusing ink.

13. The screen printing light diffusing ink according to claim 9, wherein the organic matrix comprising at least one resin in an amount from 10% to 30% by weight of the screen printing light diffusing ink dissolved in monomers, oligomers or monomers and oligomers and said matrix is at least 95% by weight of the ink, named UV-based matrix.

14. The light diffusing ink according to claim 12, wherein the resin belongs to at least one of the chemical families including polyacrylic, functionalized polyacrylic, polymethacrytic, functionalized polymethacrylic, polyvinylic, functionalized polyvinylic, polyester, polyether, hydrocarbonic, chetonic, aldehydic, maleic, polyphenolic, polyethylenic, alkedic, ureic, melaminic, polyamydic, polyamine, epoxy, epoxy-ester, epoxy-urethane, and cellulose derivative families.

15. The light diffusing ink according to claim 12, wherein the monomers are acrylates or methacrylates, both monofunctional or bifunctional or trifunctional or polyfunctional, the oligomers belonging to at least one of the chemical families including urethane acrylate, urethane methacrylate, epoxy acrylate, epoxy methacrylate, polyester acrylate, polyester methacrylate, polyether acrylate, polyether methacrylate, amino acrylate, amino methacrylate, oligoamino acrylate, and oligoatmino methacrylate oligomers.

16. The light diffusing ink according to claim 12, wherein the matrix comprises at least one fluorescent material in an amount less than 5% by weight of the ink and suitable for optically absorbing the light coming from an illuminating device.
